(19) United States
(12) Patent Application Publication
(10) Pub. No.: US 2024/0098688 A1
(43) Pub. Date: Mar. 21, 2024

(54) POSITIONING ASSISTANCE DATA DELIVERY FOR REDUCED SIGNALING OVERHEAD

(71) Applicant: QUALCOMM Incorporated, San Diego, CA (US)

(72) Inventors: Alexandros MANOLAKOS, Escondido, CA (US); Mukesh KUMAR, Hyderabad, Punjab (IN); Srinivas YERRAMALLI, San Diego, CA (US); Sven FISCHER, Nuremberg (DE)

(21) Appl. No.: 18/263,259

(22) PCT Filed: Mar. 8, 2022
(86) PCT No.: PCT/US2022/071035

§ 371 Date: Jul. 27, 2023

(30) Foreign Application Priority Data
Apr. 15, 2021 (GR) 20210100265

(51) Int. Cl. H04W 64/00; G01S 5/02; H04L 5/00

(52) U.S. Cl. CPC H04W 64/006; G01S 5/0236; H04L 5/0048

(57) ABSTRACT

Techniques for positioning assistance data (AD) delivery for reduced signaling overhead may comprise determining a combined positioning AD for a requesting user equipment (UE) based at least in part on the area ID in which the requesting UE is located. The combined positioning AD may include positioning AD for the first area and one or more additional areas. For each of the area, the positioning AD may comprise information regarding Positioning Reference Signal (PRS) resources, Base Station Almanac (BSA) information, or both, to be used for positioning the requesting UE within the respective area. The first area and the one or more additional areas may comprise cells of the wireless communication network or sidelink (SL) group zones.

### BACKGROUND

### 1. Field of Invention

The present invention relates generally to the field of wireless communications, and more specifically to determining the location of a mobile device using radio frequency (RF) signals.

### 2. Description of Related Art

Determining the location of a mobile device in a wireless communication network may involve transmitting and/or measuring RF signals by the mobile device. The mobile device, referred to as a user equipment (UE) in Long Term Evolution (LTE) and 5th Generation New Radio (5G NR) networks, may be configured to transmit and/or measure these RF signals in coordination with other mobile devices, Transmission Reception Points (TRPs), and/or Transmission Points (TPs) by means of assistance data (AD) provided to the mobile device by a location server. Traditionally, the AD is provided to the mobile device during a positioning session between the mobile device and a location server, and the AD is specific to a particular geographic area (e.g., a cell or sidelink (SL) group zone) in which the mobile device is located. If the UE moves to a new geographic area during a positioning session between the UE and location server, the UE requests new AD, which the location server provides. This can result in a large amount of overhead in cases where a UE moves between different geographic areas over the course of a positioning session, which is especially likely where the geographic areas are small and/or the UE is moving quickly.

### BRIEF SUMMARY

An example method of positioning Assistance Data (AD) delivery for positioning a requesting user equipment (UE) in a wireless communication network, according to this disclosure, comprises receiving a request, from the requesting UE, for positioning AD for a first area in which the requesting UE is located, wherein the request may comprise an area identifier (ID) of the first area. The method may further comprise determining a combined positioning AD based at least in part on the area ID, and wherein the combined positioning AD includes: positioning AD for the first area comprising information regarding Positioning Reference Signal (PRS) resources, Base Station Almanac (BSA) information, or both, to be used for positioning the requesting UE within the first area, and positioning AD for one or more additional areas comprising, for each area of the one or more additional areas an indication that the positioning AD for the first area also applies to the respective additional area, or differential information indicative of a difference between the positioning AD for the first area and the positioning AD for respective additional area. The method also may comprise sending the combined positioning AD to the requesting UE. The first area and the one or more additional areas may comprise cells of the wireless communication network or sidelink (SL) group zones.

An example method of positioning a requesting user equipment (UE) in a wireless communication network, according to this disclosure, comprises determining an area identifier (ID) for a first area in which the requesting UE is located sending, to a responding device, a request for positioning Assistance Data (AD) for the first area and one or more additional areas, wherein the request includes the area ID for the first area. The method also comprises receiving, from the responding device, a combined positioning AD comprising the positioning AD for the first area comprising information regarding Positioning Reference Signal (PRS) resources, Base Station Almanac (BSA) information, or both, to be used for positioning the requesting UE within the first area, and the positioning AD for the one or more additional areas comprising, for each area of the one or more additional areas: an indication that the positioning AD for the first area also applies to the respective additional area, or differential information indicative of a difference between the positioning AD for the first area and the positioning AD for respective additional area. The method also comprises performing an action in accordance to the combined positioning AD, wherein the action may comprise measuring a PRS resource, transmitting a PRS resource, or both. The first area and the one or more additional areas may comprise cells of the wireless communication network or sidelink (SL) group zones.

An example responding device for providing positioning Assistance Data (AD) delivery for positioning a requesting user equipment (UE) in a wireless communication network, according to this disclosure, comprises a transceiver, a memory, and one or more processing units communicatively coupled with the transceiver and the memory. The one or more processing units are configured to receive a request, from the requesting UE via the transceiver, for positioning AD for a first area in which the requesting UE is located, wherein the request may comprise an area identifier (ID) of the first area. The one or more processing units are further configured to determine a combined positioning AD based at least in part on the area ID, wherein the combined positioning AD includes: positioning AD for the first area comprising information regarding Positioning Reference Signal (PRS) resources, Base Station Almanac (BSA) information, or both, to be used for positioning the requesting UE within the first area, and positioning AD for one or more additional areas comprising, for each area of the one or more additional areas: an indication that the positioning AD for the first area also applies to the respective additional area, or differential information indicative of a difference between the positioning AD for the first area and the positioning AD for respective additional area. The one or more processing units are further configured to send the combined positioning AD to the requesting UE via the transceiver. The first area and the one or more additional areas may comprise cells of the wireless communication network or sidelink (SL) group zones.

An example requesting user equipment (UE) in a wireless communication network, according to this disclosure, comprises a transceiver, a memory, and one or more processing units communicatively coupled with the transceiver and the memory. The one or more processing units are configured to determine an area identifier (ID) for a first area in which the requesting UE is located. The one or more processing units are further configured to send, to a responding device via the transceiver, a request for positioning Assistance Data (AD) for the first area and one or more additional areas, wherein the request includes the area ID for the first area. The one or more processing units are further configured to receive, from the responding device via the transceiver, a combined positioning AD comprising the positioning AD for the first area comprising information regarding Positioning Reference Signal (PRS) resources, Base Station Almanac (BSA) information, or both, to be used for positioning the requesting UE within the first area, and the positioning AD for the one or more additional areas comprising, for each area of the one or more additional areas: an indication that the positioning AD for the first area also applies to the respective additional area, or differential information indicative of a difference between the positioning AD for the first area and the positioning AD for respective additional area. The one or more processing units are further configured to perform an action in accordance to the combined positioning AD, wherein the action may comprise measuring a PRS resource, transmitting a PRS resource, or both. The first area and the one or more additional areas may comprise cells of the wireless communication network or sidelink (SL) group zones.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3 is a call-flow diagram that illustrates an assistance data (AD) exchange during a positioning session between a user equipment (UE) and location server.

FIG. 4 is a diagram of a hierarchical structure of how positioning reference signal (PRS) resources may be identified in AD, according to an example.

FIG. 5 is a diagram of an example coverage region through which a UE is moving.

FIG. 6 is a call-flow diagram that illustrates an example AD exchange when the UE moves from one cell to another.

FIG. 7 is a diagram illustrating how UEs in various sidelink (SL) group zones may be configured for SL based positioning.

FIG. 8 is a flow diagram of a method of positioning AD delivery for positioning of a requesting UE in a wireless communication network, according to an embodiment.

FIG. 9 is a flow diagram of a method of positioning of a requesting UE in a wireless communication network, according to an embodiment.

FIG. 10 is a block diagram of an embodiment of a UE, which can be utilized in embodiments as described herein.

FIG. 11 is a block diagram of an embodiment of a base station, which can be utilized in embodiments as described herein.

FIG. 12 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

It can be noted that, although embodiments described herein largely describe the use of Transmission Reception Points (TRPs), embodiments are not so limited. As a person of ordinary skill will appreciate, a Transmission Point (TP) may be used, where possible, in addition or as an alternative to a TRP. Additional details are provided herein.

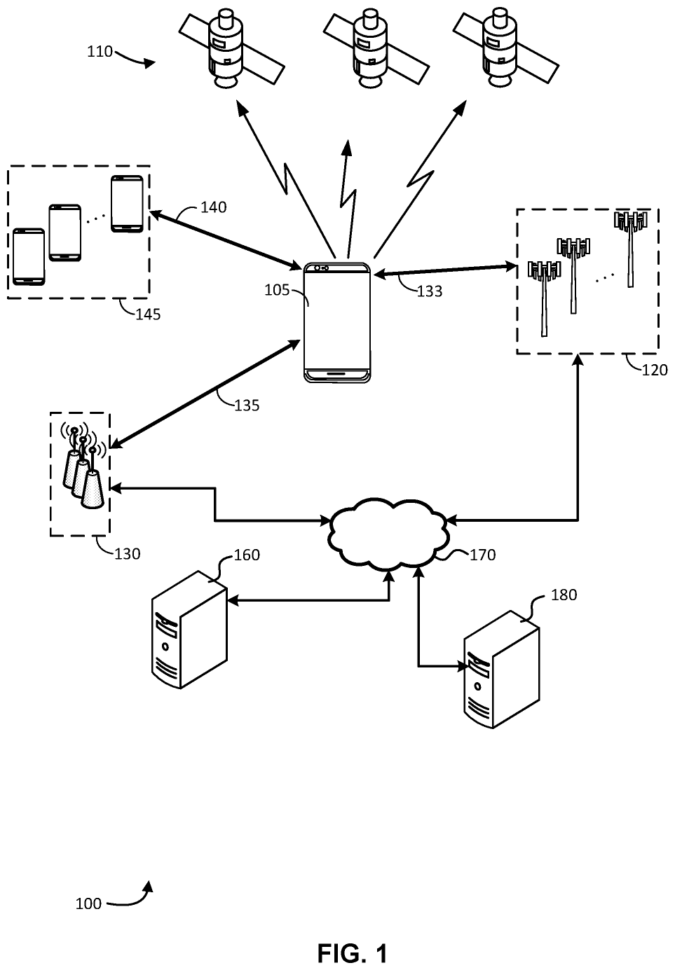

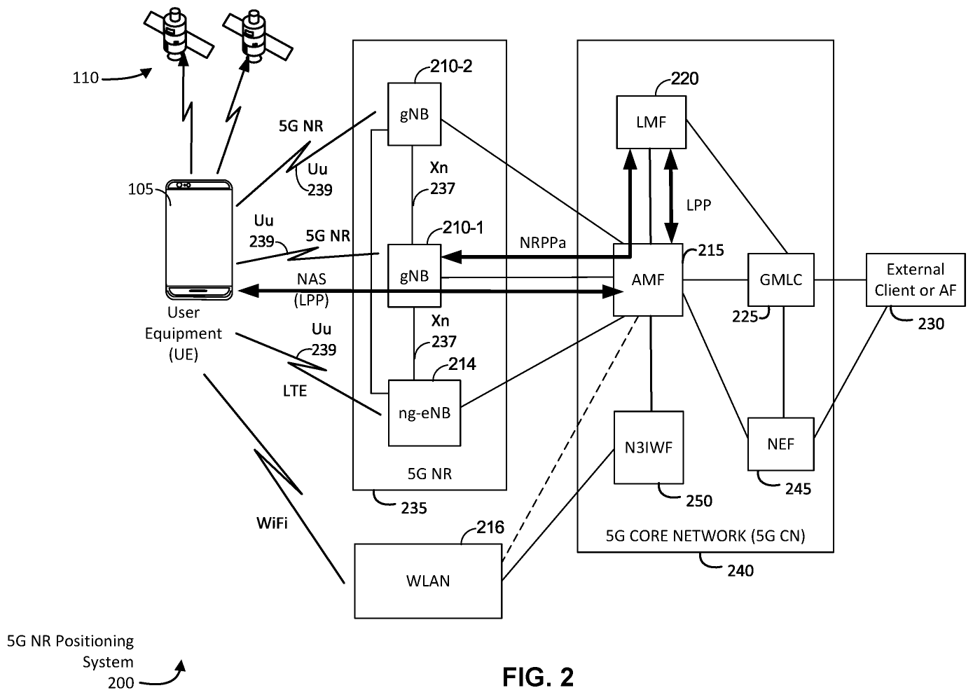

FIG. 1 is a simplified illustration of a positioning system 100 in which a UE 105, location server (LS) 160, and/or other components of the positioning system 100 can use the techniques provided herein for enabling positioning assistance data delivery for reduced signaling overhead, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; LS 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to LS 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 are communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP, for example. Thus, UE 105 can send and receive information with network-connected devices, such as LS 160, by accessing the network 170 via a base station 120 using a first communication link 133. Additionally or alternatively, because APs 130 also may be communicatively coupled with the network 170, UE 105 may communicate with network-connected and Internet-connected devices, including LS 160, using a second communication link 135.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The LS 160 may comprise a server and/or other computing device configured to determine an estimated location of UE 105 and/or provide data (e.g., “assistance data”) to UE 105 to facilitate location measurement and/or location determination by UE 105. According to some embodiments, LS 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in LS 160. In some embodiments, the LS 160 may comprise, a Discovered SLP (D-SLP) or an Emergency SLP (E-SLP). The LS 160 may also comprise an Enhanced Serving Mobile Location Center (E-SMLC) that supports location of UE 105 using a control plane (CP) location solution for LTE radio access by UE 105. The LS 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between LS 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location or some other location such as a location for UE 105 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, asset tracking or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes 210, 214, 216 (which may correspond with base stations 120 and access points 130 of FIG. 1) and (optionally) an LMF 220 (which may correspond with LS 160) to implement one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, IRNSS). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), tracking device, navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include NR NodeB (gNB) 210-1 and 210-2 (collectively and generically referred to herein as gNBs 210). Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. It is noted that while only one ng-eNB 214 is shown in FIG. 2, some embodiments may include multiple ng-eNBs 214. Base stations 210, 214 may communicate directly with one another via an Xn communication interface. Additionally or alternatively, base stations 210, 214 may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. This can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more ANs. As noted, while FIG. 2 depicts access nodes 210, 214, and 216 configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node 210, 214, or 216 of a first RAT to an access node 210, 214, or 216 of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as DL Time Difference Of Arrival (DL-TDOA)), Real Time Kinematic (RTK), Precise Point Positioning (PPP), Differential GNSS (DGNSS), Enhance Cell ID (ECID), angle of arrival (AOA), angle of departure (AOD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol A (NRPPa) as defined in 3GPP Technical Specification (TS) 38.445. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, OTDOA, multi-cell RTT, AOD, and/or ECID. The NRPPa protocol may be used to support positioning of UE 105 using network based position methods such as ECID, AOA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AOA, Receive Time-Transmission Time Difference (Rx-Tx), Differential AOA (DAOA), AOD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AOA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for OTDOA, AOD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AOD and/or AOA.

As previously noted, positioning assistance data (AD) may be provided to the UE 105 to help coordinate the UE's transmission and/or measurement of RF signals used to perform one or more types of positioning of the UE 105. In particular, for DL and/or DL-UL based positioning utilizing DL-PRS, this positioning AD may include information such as timing, periodicity, frequency, identifying information, etc. of various DL-PRS resources to enable the UE 105 to take measurements of the DL-PRS resources. For SL based positioning utilizing SL-PRS resources, the UE 105 may measure SL-PRS resources from one or more other UEs (referred to herein as SL UEs) and/or transmit SL-PRS resources to one or more other UEs.

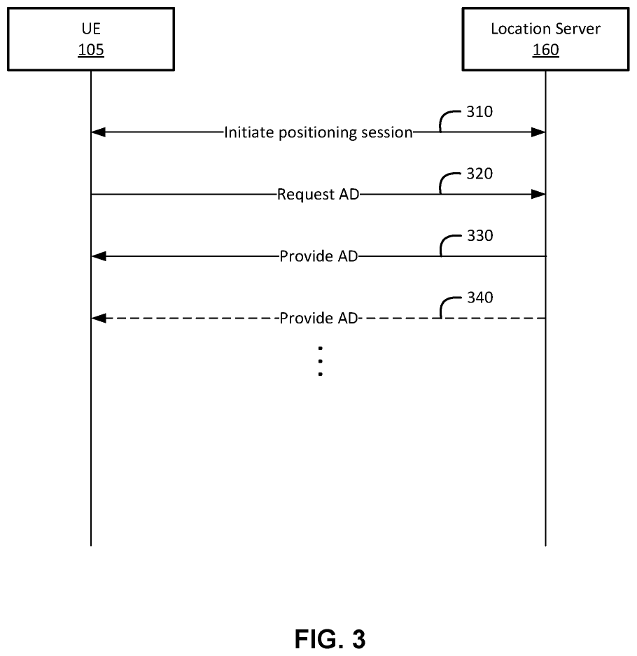

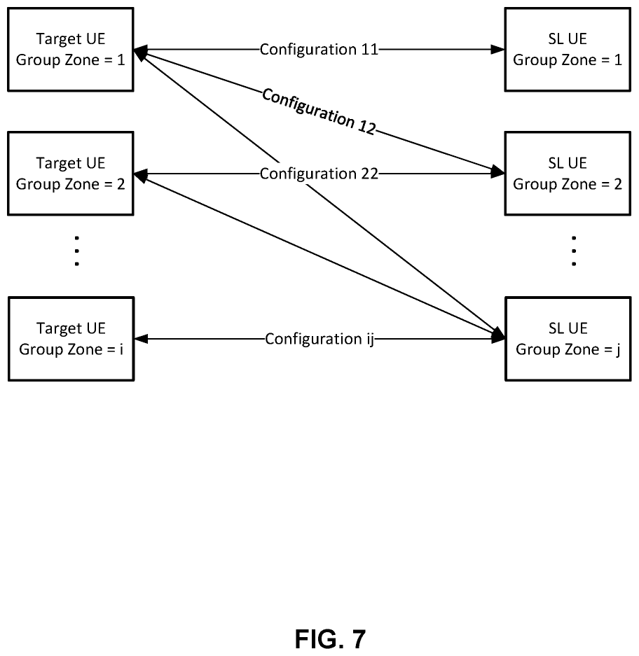

Embodiments herein for optimizing positioning AD delivery for the positioning of a UE may apply to DL and DL-UL (referred to hereinafter as “Uu positioning” or “Uu-based positioning”) as well as SL-based positioning, where the reference signals used for positioning may comprise DL-PRS resources and/or SL-PRS resources (generically referred to herein as PRS resources or PRS). As such, the content of the positioning AD (also referred to herein simply as AD) may vary, as described hereinafter, based on the type of positioning performed. The functionality of embodiments involving DL-PRS is described below with regard to FIGS. 3-6, then expanded to SL-PRS with regard to FIG. 7 and thereafter.

FIG. 3 is a call-flow diagram that illustrates how AD may be requested by a UE 105 and received from a location server 160 (e.g., LMF 220) during the course of a positioning session between the UE 105 and location server 160. This can represent, for example, an LPP positioning session between the UE 105 and location server 160, although embodiments are not necessarily limited to LPP positioning. Further, although FIG. 3 illustrates a particular positioning AD transfer process, the particular process in alternative embodiments may vary.

Here, the positioning session between the UE 105 and location server 160 is initiated, as indicated at arrow 310. Based on the type of positioning (e.g., UE-assisted or UE-based) the positioning session may be initiated by the UE 105 (e.g., in the case of UE-based) or location server 160 (e.g., in the case of UE-assisted). Preliminary information such as capabilities of the UE 105 and/or location server 160 may be exchanged. The initiation of the positioning session at arrow 310 may further indicate the types of positioning to be performed (e.g., based on capabilities). This may include positioning types for which measurement information taken by the UE 105 is to be reported back to the location server 160. Such positioning types can include, for example, multi-RTT positioning, DL-AoD positioning, DL-TDOA positioning, Enhanced Cell ID (E-CID) positioning, etc.

The UE 105 may then request assistance data (AD), as indicated by dashed arrow 320. To help ensure the location server 160 provides AD with configuration information regarding PRS resources relevant to where the UE 105 is located, the UE 105 can provide an indication of the cell in which the UE 105 is located. For example, the UE 105 may provide an ID of its serving TRP (e.g., the “primaryCellID” information element (IE) in relevant 3GPP wireless standards). In response, the location server 160 may determine the AD to provide the UE 105 based, at least in part, on the cell in which the UE 105 is located, and provide the AD to the UE 105, as indicated at arrow 330. Depending on the type of positioning session, the location server 160 may periodically provide additional AD thereafter, as indicated at arrow 340. (The positioning session subsequently may include operations (not shown) in which PRS measurements and/or estimated position of the UE 105 are exchanged.)

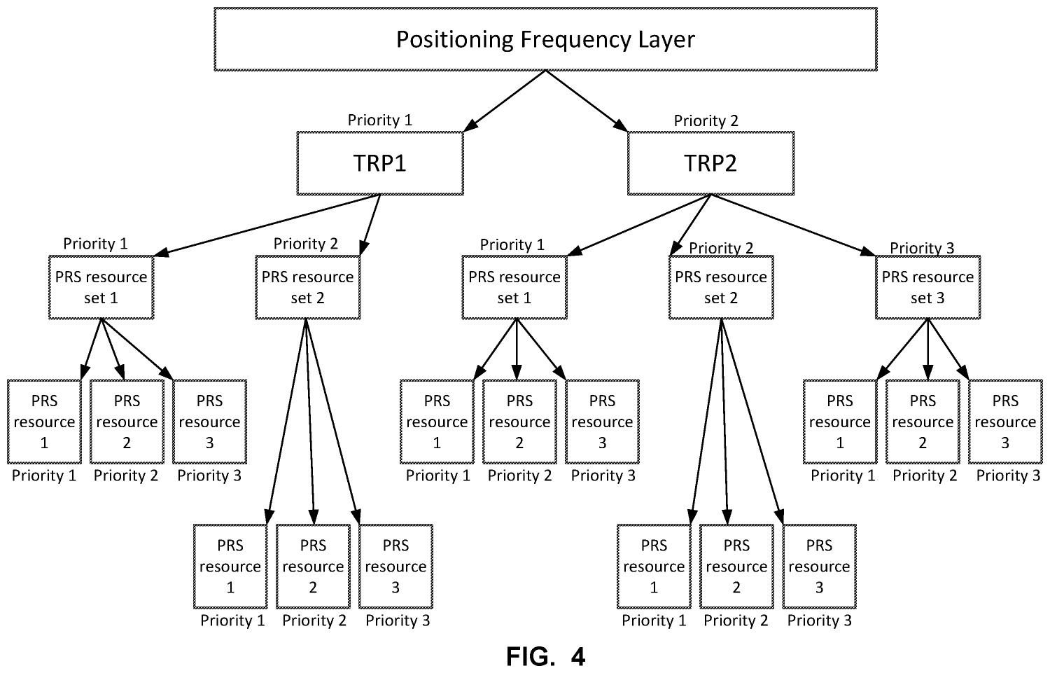

As noted, identifying information for reference signals (PRS resources) can involve a large amount of signaling overhead. This is due, in part, because of the hierarchical structure of PRS resources. The structure is illustrated in more detail in FIG. 4.

FIG. 4 is a diagram of a hierarchical structure of how PRS resources and PRS resource sets may be used by different TRPs of a given Positioning Frequency Layer (PFL) as defined in 5G NR, according to an example. In brief, a UE may have certain capabilities with regard to being able to aggregate reference signals (PRS resources) transmitted by one or more TRPs in a PFL. The use of multiple PRS resources in multiple PFLs can effectively increase the bandwidth of the reference signals for a measurement taken to determine the location of the UE. More particularly, this increase in bandwidth comes by aggregating the PRS resources (e.g., processing the reference signals jointly in the signal domain). The UE's ability to aggregate or transmit these reference signals may be limited by channel spacing, timing offset, phase offset (or phase misalignment), frequency error, power imbalance, and other such factors between reference signals of different PFLs.

With respect to a network (Uu) interface, a UE 105 can be configured by a location server 160 with one or more PRS resource sets from each of one or more TRPs. Each PRS resource set includes K≥1 PRS resource(s), which may correspond to a Tx beam of the TRP. A PRS PFL is defined as a collection of PRS resource sets which have the same subcarrier spacing (SCS) and cyclic prefix (CP) type, the same value of PRS bandwidth, the same center frequency, and the same value of comb size. In current iterations of the NR standard, a UE 105 can be configured with up to four DL PRS PFLs.

NR has multiple frequency bands across different frequency ranges (e.g., Frequency Range 1 (FR1) and Frequency Range 2 (FR2)). PFLs may be on the same band or different bands. Additionally, as illustrated in FIG. 4, multiple TRPs (e.g., TRP1 and TRP2) may be on the same PFL. Each TRP can have multiple PRS resource sets, each with one or more PRS resources. In the example PFL illustrated in FIG. 4, TRP1 has two PRS resource sets, and TRP2 has three PRS resource sets. Each PRS resource set has three PRS resources, totaling in 15 PRS resources. (It can be noted, however, that the number of TRPs, PRS resource sets, and PRS resources, can vary from the number illustrated in the example in FIG. 4. For example, different PRS resource sets of the same TRP or PFL may have different numbers of PRS resources.) A PRS “sequence” comprises the PRS resources used in a positioning session of a UE 105 to determine the location of the UE 105. Each sequence may be specific to the UE 105, although different PRS resources within the sequence may be broadcast and measured by multiple UEs at a time.

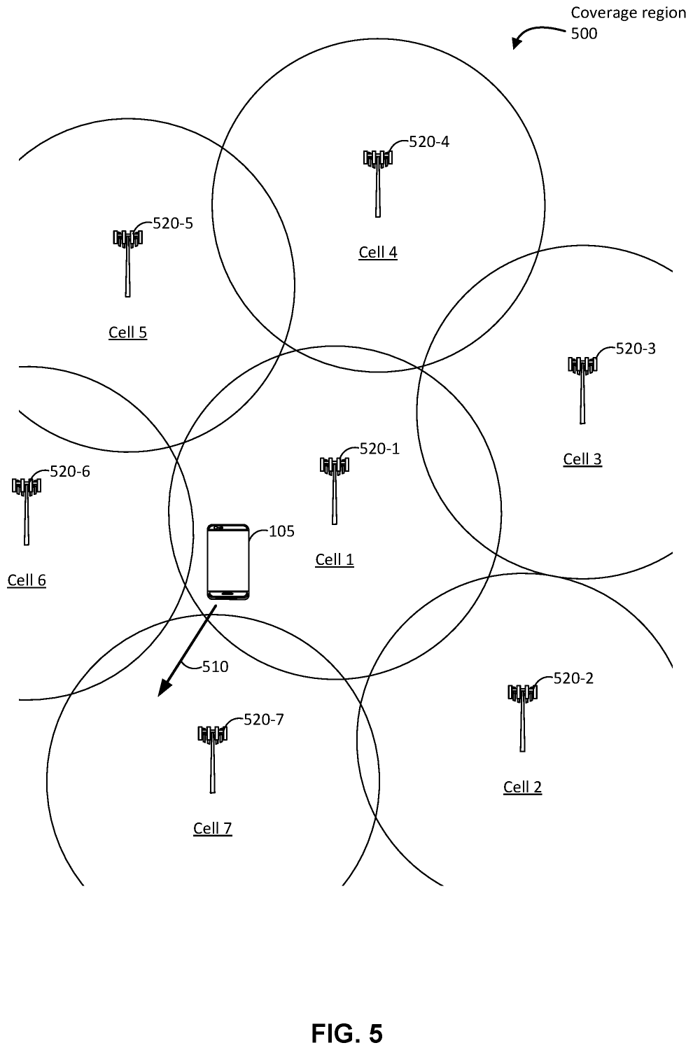

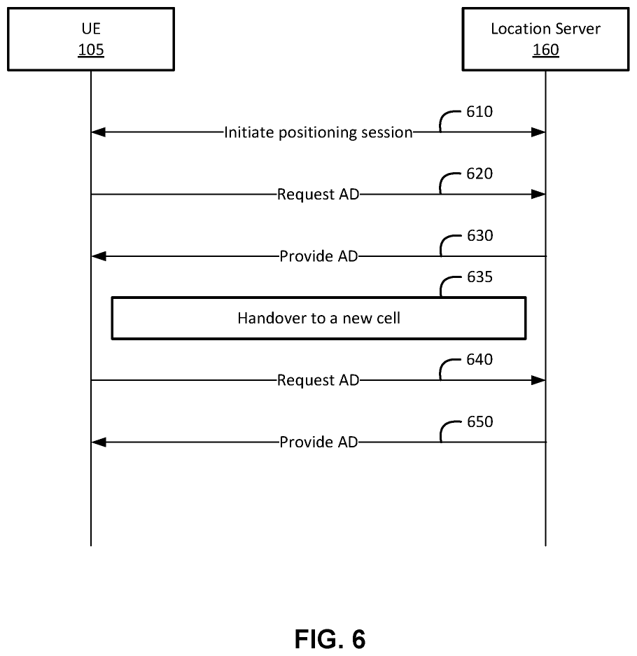

The AD provided by a location server 160 can include configuration information that provides detailed information regarding each PRS resource, including the hierarchical structure illustrated in FIG. 4. That is, the AD can include information such as timing, frequency, etc. for each PRS resource, as well as identifying information of each PRS resource that indicates the corresponding PRS resource set, TRP, and PFL of each resource. The relatively large amount of data included in the AD may therefore be costly in terms of bandwidth and overhead each time the location server 160 sends the AD to the UE 105. This cost is exacerbated in situations in which the location of the UE 105 changes, resulting in a new request/receipt of additional AD. As illustrated in FIGS. 5 and 6, such situations can include, for example, situations in which the UE 105 is moving through a region of small cells.

FIG. 5 is a diagram of a coverage region 500 through which UE 105 is moving in the direction of arrow 510. As a person of ordinary skill in the art will appreciate, the coverage region 500 in FIG. 5 is a simplified representation of region of wireless coverage by a wireless indication network (e.g., network 170), which may have several coverage regions expanding a large geographic area. The coverage region 500 is divided into various cells, Cell 1 to Cell 7, which are respectively served by TRPs 520-1 to 520-7 (e.g., corresponding to base stations 120, gNBs 210, and/or ng-eNB 214). Thus, when the UE 105 is in Cell 1, the UE 105 can send a request for AD that includes the ID of Cell 1 to a location server 160, in in the manner previously described. Using the cell ID of Cell 1, the location server 160 can then provide AD to the UE 105 that is specific to UEs in that cell, with configuration information regarding PRS resources that the UE 105 should be able to measure given its position within Cell 1. Typically, PRS resources transmitted by the serving TRP will have highest priority. Thus, the AD provided to the UE 105 in Cell 1 may prioritize PRS resources from TRP 520-1.

When the UE 105 moves from one cell to another, a handover process occurs in which the TRP of the cell into which the UE 105 is moving becomes the new serving TRP. Thus, in the example illustrated in FIG. 5, when UE 105 moves from Cell 1 to Cell 7, the serving TRP for the UE 105 will transition from TRP 520-1 to TRP 520-7. This can trigger a new request by the UE 105 for AD applicable to the new cell (Cell 7).

FIG. 6 is a call-flow diagram that illustrates a basic exchange of assistance data (AD) and reporting between a UE 105 and location server 160 (e.g., LMF 220) when the UE 105 moves from one cell to another. The operations corresponding to arrows 610-630 echo corresponding operations 310-330 in FIG. 3, as previously described. In contrast to FIG. 3, however, the process illustrated in FIG. 6 includes a handover to a new cell, at block 635. This handover can be triggered when the UE changes cells. This prompts the UE 105 to make a request for new AD, shown at arrow 640, that is applicable to the new cell. The request may therefore include the cell ID of the new cell in which the UE 105 is located. And at arrow 650, the location server 160 provides the new AD based on the cell ID provided in the request.

Operations 635-650 may repeat over the course of the positioning session between the location server 160 and UE 105 each time a UE 105 enters a new cell. Thus, returning to FIG. 5, the smaller Cells 1 to 7 are and/or the faster the UE 105 is moving, the more likely a handover will occur during the positioning session, resulting in inefficiencies arising with new AD requests from the UE 105 and new AD from the location server 160.

Similar inefficiencies in the exchange of AD arise in SL positioning, although the structure and exchange of AD in SL based positioning differ somewhat from the Uu based positioning described above in relation to FIGS. 3-6. FIG. 7 is used to help illustrate inefficiencies of AD in SL positioning.

FIG. 7 is a diagram illustrating how UEs in various “group zones” may be configured for SL based positioning. In SL-based positioning, geographic regions can be divided into a grid of areas known as group zones, which may currently range from 5×5 m to 50×50 m. Each group zone may be associated with a corresponding resource Pool for positioning (RP-P) comprising SL PRS resources communicated between UEs for positioning. Again, to position a target UE, the target UE may measure SL PRS resources transmitted by one or more SL UEs and/or transmit SL PRS resources to the SL UEs. RP-P configurations may be assigned to a target UE or SL UE by a TRP or UE.

As illustrated in FIG. 7, configurations for a target UE and an SL UE may depend on the group zones in which the target UE and SL UE are located. Configurations are given the “configuration ij” notation where “i” is the group zone of the target UE and “j” is the group zone of the SL UE. Similar to receiving new AD after moving from one cell to another (as previously described in relation to FIG. 5), if a target mobile device moves from one zone to another (e.g., from group zone 1 to group zone 2), AD with new configurations may need to be sent to the target UE and the SL UE. Moreover, because the SL UE may also be mobile, AD with new configurations may need to be sent if the SL UE moves from one group zone to another.

To address issues including inefficiencies arising from additional AD exchanges when a UE changes cells or group zones in a positioning session, embodiments herein provide for an efficient AD exchange in which AD provided to a UE may include AD not only for a current area (e.g., cell or group zone) in which the UE is located, but also one or more neighboring areas into which the UE may move during the positioning session. When a UE receives this “combined” positioning AD for multiple areas, it may therefore not need to request additional AD one moving from one area to another, which can save time and bandwidth.

Depending on desired functionality, implementations may provide combine AD for multiple areas in any of a variety of ways.

First, because AD may be the same for multiple neighboring cells or group zones, the combined AD may simply provide AD for the current area in which the UE is located (e.g., based on the cell ID or group zone ID provided by the UE), with an indication of all areas for which the AD applies. Returning to FIG. 5, for example, the UE 105 located in Cell 1 may request AD for Cell 1. However, the location server can provide, in response, combine AD that indicates the AD is applicable not only to Cell 1, but also to neighboring cells Cell 2 and Cell 7. In other words, the UE 105 measures the same PRS resources in Cells 2 and 7 as it would for Cell 1. Thus, if the UE 105 moves to either Cell 2 or Cell 7, it will not need to request further AD, but could simply proceed with the AD it received for 1.

A second implementation involves including, with the AD for the area in which the UE is located, “differential” information for one or more neighboring cells. The differential information indicates how the AD for one or more neighboring cells is different from the AD for the cell in which the UE is currently located. This may comprise adding PRS resources, moving PRS resources, and/or altering the priority of PRS resources in the AD.

For example, the AD of Cell 1 in FIG. 5 may comprise information for PRS resources {PRS0, PRS1, PRS2, PRS3, PRS4, PRS5, PRS6, PRS7}, where the number of each PRS resource (0-7) represents its priority in the sequence. The combined AD provided to the UE 105 by a location server during a positioning session may include this information for Cell 1, along with differential information for Cell 7. This differential information may comprise instructions to remove PRS1 and PRS2, and add PRS2′ (a PRS different from PRS2 but with the same priority) and PRS8. If the UE 105 subsequently moves to Cell 7 during the course of the positioning session, the UE 105 can construct the AD for Cell 3: {PRS0, PRS3, PRS4, PRS5, PRS6, PRS7, PRS2′, PRS8}.

A third implementation may comprise modifying the AD for the area in which the UE is located using differential information similar to the second implementation described above. In this implementation, however, changes may not be limited to the addition, subtraction, or change in prioritization of specific PRS resources, but instead may involve changes to any of the hierarchical structure of the AD (e.g., illustrated in FIG. 4). That is, changes not only may add or subtract PRS resources, but may also add or subtract PRS resource sets, TRPs, and/or PFLs. Prioritization within resource sets, TRP is, and PFLs may be inherent, as shown in FIG. 4 (e.g., based on an ordering of the PFL, TRP, PRS resource set, and PRS resources). Differential information may adjust the priority of PRS resources by indicating where a PRS resource, PRS resource set, TRP, or PFL is to be added/subtracted from the original AD. In some embodiments, the UE may give the serving TRP of the cell in which the UE is located top priority unless explicitly indicated otherwise, based on the assumption that the quality of PRS resources transmitted by the serving TRP and measured by the UE is likely to be high. In this manner, embodiments may determine a priority of PRS resources within AD based on explicit indications in the AD and/or implicit rules for interpreting the AD.

A fourth implementation may comprise providing information regarding resources for a superset of areas (e.g., the group zone in which the UE is located and one or more nearby group zones, or the cell in which the UE is located and one or more nearby cells), with details regarding how to construct the AD for each area. For example, the AD may include details regarding PRS resources PRS0-PRS100. The AD for each area may comprise a list or vector of which PRS resources to use, which may be in order of priority. For example, the AD for Cell 1 may comprise {PRS0, PRS11, PRS15, PRS18, PRS24, PRS35, PRS42, PRS47}, the AD for Cell 2 may comprise {PRS6, PRS22, PRS25, PRS28, PRS34, PRS35, PRS41, PRS49}, etc.

Depending on desired functionality, the determination or selection of the neighboring areas for which to include AD information in the combined AD may vary. In some embodiments, for example, all neighboring or adjacent areas may be chosen, or all areas within a threshold distance may be chosen. For cells, this may be based on a map and/or an indication of a proximity/distance between the cell in which the UE is located. For SL group zones, this may comprise expanding the zone parameters (e.g., from a 5×5 zone to a 50×50 zone that may be centered, for example, on the original 5×5 zone in which the UE is located).

Additionally or alternatively, the determination or selection of neighboring areas may comprise a “smart” determination based on current and/or historical location and/or movement of the UE and/or other UEs. Returning to FIG. 5, for example, because the UE 105 is located near band/or moving toward the border of Cell 1 and Cells 6 and 7, AD for Cells 6 and 7 may be included in the combined AD. If the UE 105 were moving in the opposite direction (e.g., toward the border between Cell 1 and Cells 4 and 5), however, the combined AD may include AD for Cells 4 and 5. Additionally or alternatively, a pattern of movement determined from other UEs may inform this neighboring area selection. If the coverage region 500 covered a section of the highway along which the pattern of UE movement predictably moves from Cell 4 to Cell 1 to Cell 7, for example, combine AD may be provided to the UE 105 while in (or approaching) Cell 4 that includes AD for Cells 1 and 7. A similar application could be made for combine AD applicable to SL group zones.

Additionally or alternatively, embodiments may be sensitive to the memory capacity of a UE. That is, at the beginning of a positioning session, a UE may provide capacity information including its memory capacity for storing AD. With this in mind, the location server (for Uu positioning) or other responding device (e.g., SL UE or TRP for SL positioning) can increase or limit the number of areas for which AD is provided in the combined AD based on this capacity. The larger the capacity for AD storage, the more areas for which AD may be included in the combined AD, resulting in fewer AD exchanges and increased bandwidth efficiency.

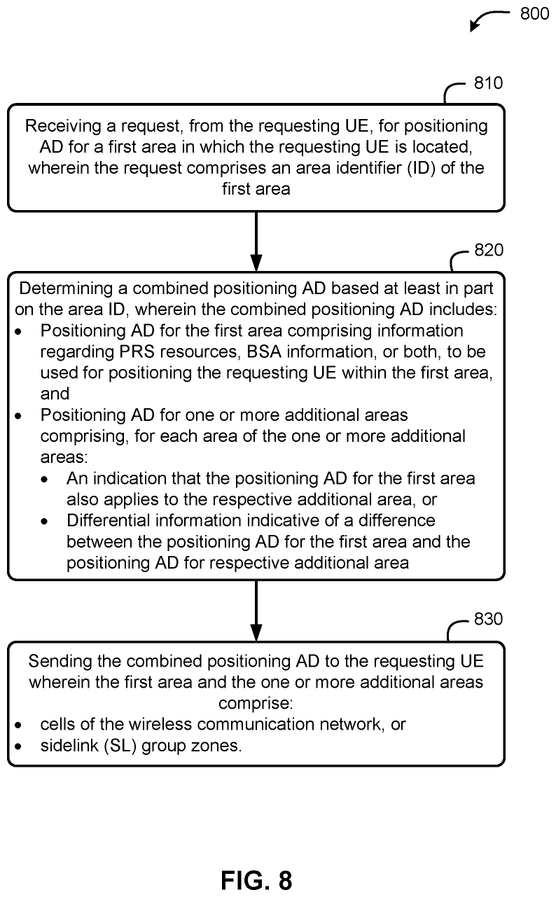

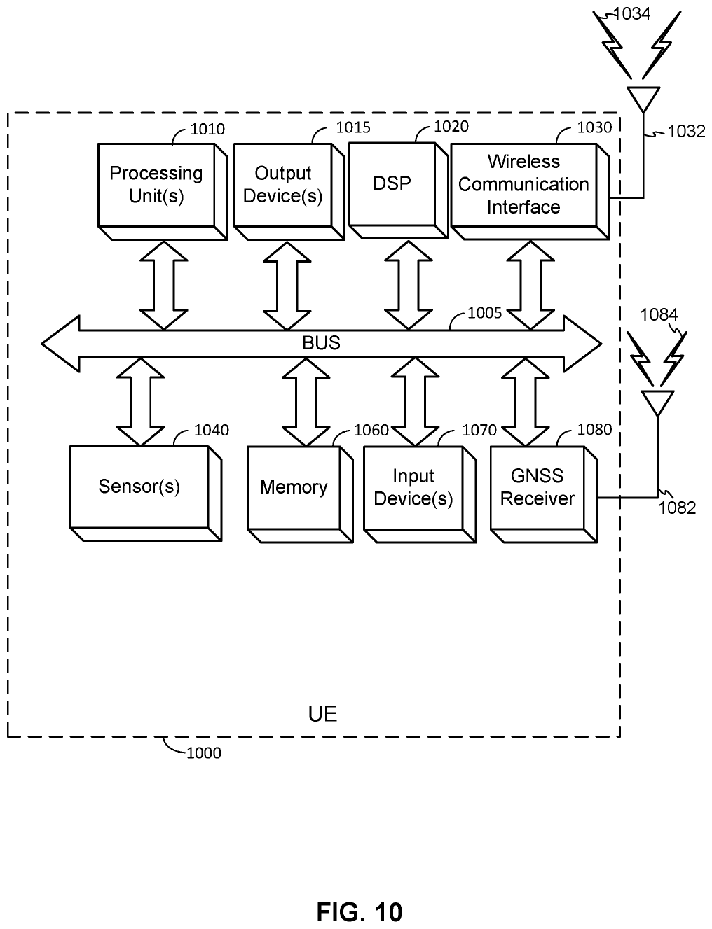

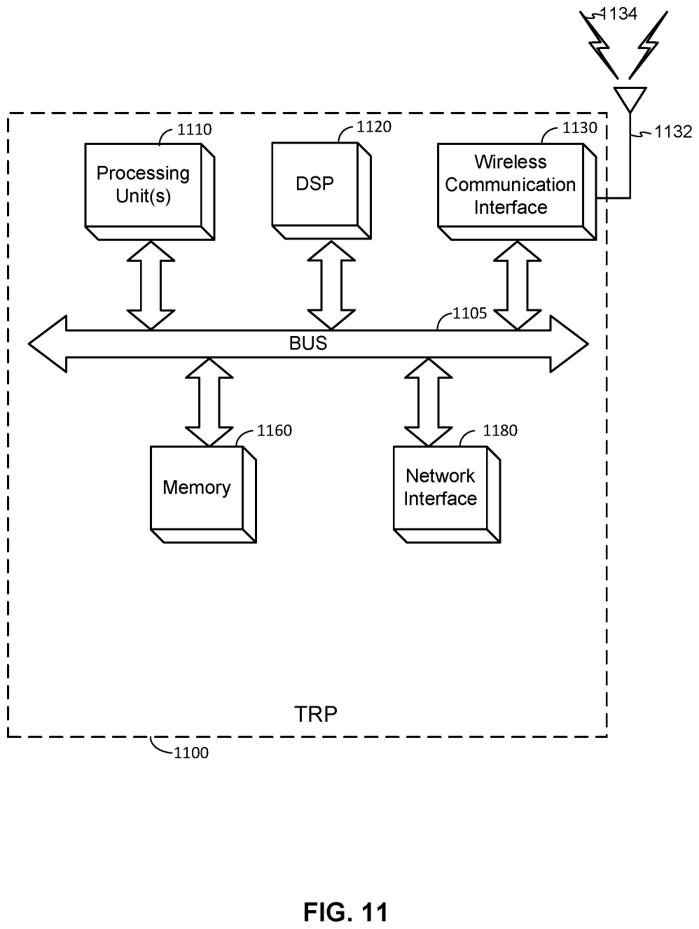

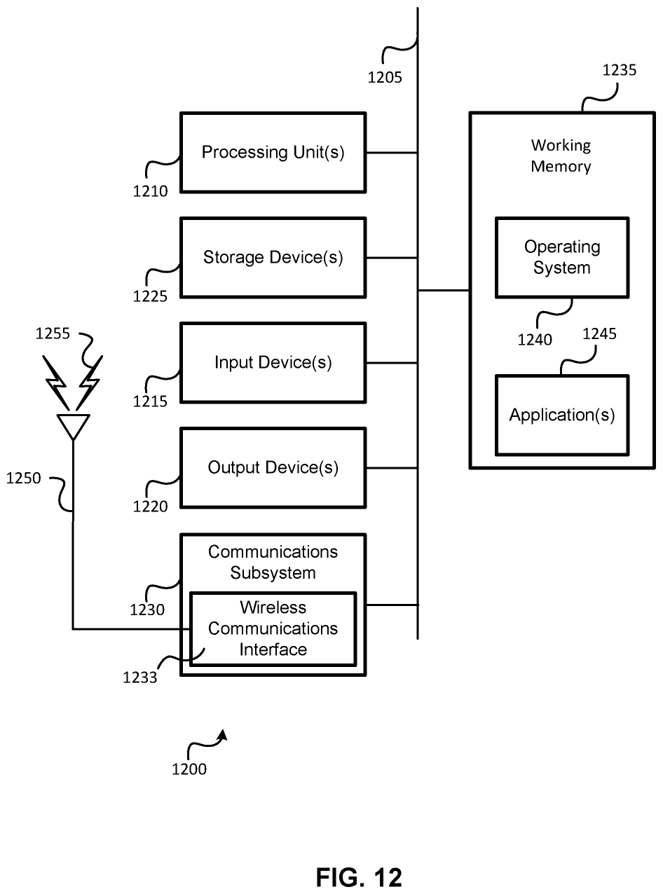

FIG. 8 is a flow diagram of a method 800 of positioning AD delivery for positioning a requesting UE in a wireless communication network, according to an embodiment. One or more of the functions shown in the blocks of FIG. 8 may be performed by a responding device providing AD, such as a location server (for Uu positioning) or another responding device (e.g., SL UE or TRP for SL positioning). As such, means for performing the functionality illustrated in one or more of the blocks shown in FIG. 8 may be performed by hardware and/or software components of a UE, TRP, or location server. Example components of a UE are illustrated in FIG. 10, example components of a TRP are illustrated in FIG. 11, an example components of a location server (computer system) are illustrated in FIG. 12, all of which are discussed hereafter.

At block 810, the functionality comprises receiving a request, from the requesting UE, for positioning AD for a first area in which the requesting UE is located, wherein the request comprises an area identifier (ID) of the first area. As noted in the embodiments above, the type of area for which AD is requested may vary depending on whether Uu or SL positioning of the requesting UE is being performed. For Uu positioning, the area may comprise a cell, whereas for SL positioning, the area may comprise an SL group zone. Accordingly, the area ID of the first area may comprise a cell ID (e.g., a Physical Cell ID (PCI), New Radio (NR) Cell Global Identity (NCGI), etc. of the current primary serving cell for the requesting UE) or SL group zone ID. According to some embodiments, the first area and the one or more additional areas may comprise cells of the wireless communication network, and the cells correspond to a TRP, a TP, or a gNB with one or more identifiers comprising a PCI, an Absolute Radio-Frequency Channel Number (ARFCN), a NCGI, or TRP identifier (TRP-ID), or a combination thereof.

Means for performing functionality at block 810 may comprise bus 1005, processing unit(s) 1010, digital signal processor (DSP) 1020, a wireless communication interface 1030, memory 1060, and/or other components of a UE 1000, as illustrated in FIG. 10. Alternatively, means for performing functionality at block 810 may comprise bus 1105, processing unit(s) 1110, digital signal processor (DSP) 1120, a wireless communication interface 1130, memory 1160, and/or other components of a TRP 1100, as illustrated in FIG. 11. Alternatively, means for performing functionality at block 810 may comprise bus 1205, processing unit(s) 1210, communications subsystem 1230, working memory 1235, and/or other components of a UE 1200, as illustrated in FIG. 12.

At block 820, the functionality comprises determining a combined positioning AD based at least in part on the area ID, wherein the combined positioning AD includes (i) positioning AD for the first area comprising information regarding PRS resources, Base Station Almanac (BSA) information, or both, to be used for positioning the requesting UE within the first area, and (ii) positioning AD for one or more additional areas comprising, for each area of the one or more additional areas: an indication that the positioning AD for the first area also applies to the respective additional area, or differential information indicative of a difference between the positioning AD for the first area and the positioning AD for respective additional area. As noted in the embodiments described previously, according to some embodiments, the one or more additional areas may comprise one or more neighboring areas to the first area. Additionally or alternatively, the one or more additional areas may comprise non-neighboring (e.g., non-adjacent) cells. Again, PRS resources may vary, depending on the type of positioning (Uu or SL) performed. Thus, according to some embodiments of the method 800, the PRS resources of the combined positioning AD may comprise a downlink PRS (DL-PRS) resource for the requesting UE to measure, a sidelink PRS (SL-PRS) resource for the requesting UE to measure, or an SL-PRS resources for the requesting UE to transmit, or a combination thereof. BSA information may include a location and one or more identifiers of a base station/TRP (e.g., Cell Global Identity (CGI), Physical Cell Id (PCI), etc.)

As previously noted, the way in which AD for additional areas is included in the combined AD may vary, depending on desired functionality. According to some embodiments, the indication that the positioning AD for the first area also applies to an additional area may simply be an identifier of the additional area. In embodiments in which differential information is provided to indicate a difference between the positioning AD for the first area and the positioning AD for respective additional area, the difference may comprise a difference in priority of the PRS resources in the positioning AD for the first area, one or more PRS resources to add to the PRS resources of the positioning AD for the first area, or one or more PRS resources to omit from the PRS resources of the positioning AD for the first area, or a combination thereof. As indicated previously, differential information may be determined and/or provided based on the hierarchical structure of PRS resources. Thus, some embodiments of the method 800 may further comprise determining the positioning AD for each area of the one or more additional areas, based, at least in part on a positioning frequency layer (PFL) of the respective additional area, a serving TRP of the respective additional area, a resource set of one or more PRS resources of the respective additional area, or one or more PRS resources of the respective additional area, or a combination thereof. Alternatively, as noted, AD may comprise a superset of PRS resources for multiple areas, and particular PRS resources can be identified and prioritized to construct the AD for a given area. Accordingly, according to some embodiments of the method 800, for each area of the one or more additional areas, the positioning AD comprises a priority index indicative of a priority of each of the PRS resources for the respective additional area.

Additionally or alternatively, the selection of additional areas can be based on current and/or historical data of the UE and/or other UEs. Thus, in some embodiments, determining the combined positioning AD comprises identifying the one or more additional areas based, at least in part on information regarding a historical position of the requesting UE, a current position of the requesting UE, a historical velocity of the requesting UE, a current velocity of the requesting UE, historical information regarding one or more additional UEs, or current information regarding one or more additional UEs, or a combination thereof.

According to some embodiments, the size of the AD (e.g., number of additional areas for which the combine AD applies) may be dependent, at least in part, on the memory capabilities of the requesting UE. As such, according to some embodiments, the method 800 may further comprise limiting a number of the one or more additional areas for which positioning AD is included in the combined positioning AD based at least in part on a capability related to a maximum number of ADs the requesting UE can support. This can include, for example, a memory limitation and/or processing limitation of the requesting UE.

According to some embodiments, the AD maybe tailored to SL positioning. For example, according to some embodiments of the method 800, the first area comprises a first SL group zone in which the requesting UE is located, the one or more additional areas comprise one or more additional SL group zones, and the area ID comprises a zone ID of the first SL group zone. In such embodiments, the combined positioning AD may comprise an SL-PRS or Resource Pool for Positioning (RP-P) configuration associated with the first SL group zone and the one or more additional SL group zones.

Means for performing functionality at block 820 may comprise bus 1005, processing unit(s) 1010, digital signal processor (DSP) 1020, memory 1060, and/or other components of a UE 1000, as illustrated in FIG. 10. Alternatively, means for performing functionality at block 820 may comprise bus 1105, processing unit(s) 1110, digital signal processor (DSP) 1120, memory 1160, and/or other components of a TRP 1100, as illustrated in FIG. 11. Alternatively, means for performing functionality at block 820 may comprise bus 1205, processing unit(s) 1210, working memory 1235, and/or other components of a UE 1200, as illustrated in FIG. 12.

At block 830, the functionality comprises sending the combined positioning AD to the requesting UE wherein the first area and the one or more additional areas comprise cells of the wireless communication network, or SL group zones. In Uu positioning, where the responding device comprises a location server, the AD may be sent, for example, in an LPP message relayed to the requesting UE via the serving TRP. For SL positioning, where the responding device comprises a TRP or SL UE, the AD may be provided via direct wireless communication. Means for performing functionality at block 830 may comprise bus 1005, processing unit(s) 1010, digital signal processor (DSP) 1020, a wireless communication interface 1030, memory 1060, and/or other components of a UE 1000, as illustrated in FIG. 10. Alternatively, means for performing functionality at block 830 may comprise bus 1105, processing unit(s) 1110, digital signal processor (DSP) 1120, a wireless communication interface 1130, memory 1160, and/or other components of a TRP 1100, as illustrated in FIG. 11. Alternatively, means for performing functionality at block 830 may comprise bus 1205, processing unit(s) 1210, communications subsystem 1230, working memory 1235, and/or other components of a UE 1200, as illustrated in FIG. 12.

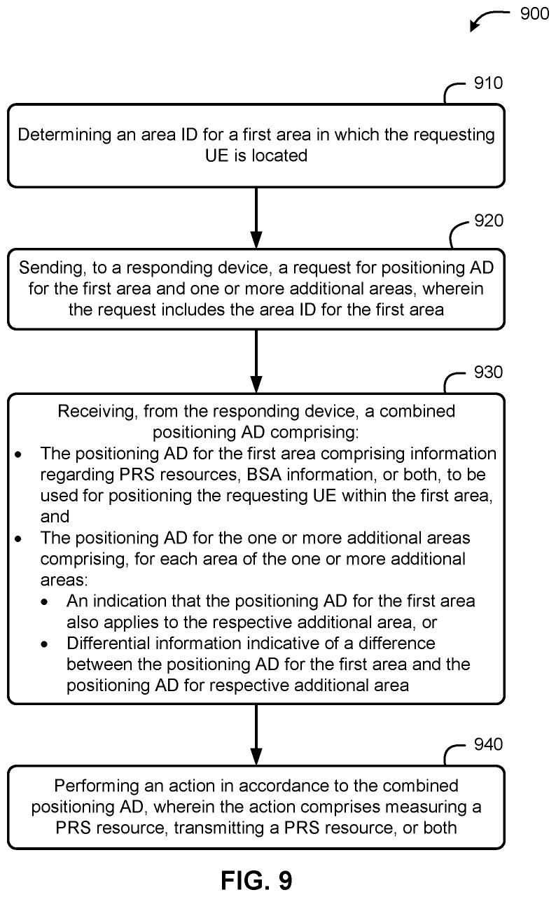

It can be noted that embodiments may allow for a requesting UE to determine the additional areas for which AD may be requested. An example embodiment is illustrated in FIG. 9.

FIG. 9 is a flow diagram of a method 900 of positioning of a requesting UE in a wireless communication network, according to an embodiment. One or more of the functions shown in the blocks of FIG. 9 may be performed by the requesting UE itself, for Uu positioning or SL positioning. As such, the requesting UE may send a request to a location server, TRP, or SL UE. Means for performing the functionality illustrated in one or more of the blocks shown in FIG. 8 may be performed by hardware and/or software components of a UE. Again, example components of a UE are illustrated in FIG. 10 and discussed hereafter.

At block 910, the functionality comprises determining an area ID for a first area in which the requesting UE is located. In the case of Uu positioning, cell IDs may include the cell ID of the serving TRP of the UE (e.g., a Physical Cell ID (PCI), New Radio (NR) Cell Global Identity (NCGI), etc. of the current primary serving cell for the requesting UE). For SL positioning, the UE may simply request AD for the group zone in which the UE is currently located. Means for performing functionality at block 910 may comprise bus 1005, processing unit(s) 1010, digital signal processor (DSP) 1020, a memory 1060, and/or other components of a UE 1000, as illustrated in FIG. 10.

The functionality at block 920 comprises sending, to a responding device, a request for positioning AD for the first area and one or more additional areas, wherein the request includes the area identifier for the first area. According to some embodiments, the one or more additional areas may comprise one or more neighboring areas to the first area. Additionally or alternatively, the one or more additional areas may comprise non-neighboring (e.g., non-adjacent) cells. Again, the responding device may comprise a location server, TRP, or a responding UE (e.g., SL UE). Depending on desired functionality, the request may include different items of information. According to some embodiments, for example, the request for AD may include an indication of a capability of the requesting UE to receive AD for the one or more additional areas. This may simply be a flag (e.g., a bit) that indicates that requesting UE is capable of processing and is requesting AD for additional areas, in which case the responding device can determine the additional areas.

Alternatively, the requesting UE may area IDs of the one or more additional areas and include, in the request for AD, the area IDs of the one or more additional areas. In the case of Uu positioning, cell IDs included in the request for AD may include the cell ID of the serving TRP of the UE, as well as cell IDs of one or more other TRPs detected by the requesting UE. This may include all TRPs detected by the UE or TRPs for which a wireless signal quality metric (e.g., SNR) exceeds a threshold value. For SL positioning, the UE may simply request AD for group zones adjacent to the group zone in which the UE is currently located, and/or group zones within a threshold distance of the group zone in which the UE is currently located.

Similar to embodiments in which a responding device determines nearby areas, the requesting UE can engage in “smart” determination of nearby areas, according to some embodiments. As such, according to some embodiments, determining the area identifiers for the one or more additional areas may comprise identifying the one or more additional areas based, at least in part on information regarding a historical position of the requesting UE, a current position of the requesting UE, a historical velocity of the requesting UE, a current velocity of the requesting UE, historical information regarding one or more additional UEs, or current information regarding one or more additional at UEs, or a combination thereof. Additionally or alternatively, the request may accommodate memory limitations of the requesting UE. As such, alternative embodiments of the method 900 may further comprise limiting a number of the one or more additional areas for which area IDs are included in the request based at least in part on a memory limitation of the requesting UE.

Means for performing functionality at block 920 may comprise bus 1005, processing unit(s) 1010, digital signal processor (DSP) 1020, a wireless communication interface 1030, memory 1060, and/or other components of a UE 1000, as illustrated in FIG. 10.

At block 930, the functionality comprises receiving, from the responding device, a combined positioning AD comprising (i) the positioning AD for the first area comprising information regarding Positioning Reference Signal (PRS) resources, BSA information, or both, to be used for positioning the requesting UE within the first area, and (ii) the positioning AD for the one or more additional areas, comprising, for each area of the one or more additional areas: an indication that the positioning AD for the first area also applies to the respective additional area, or differential information indicative of a difference between the positioning AD for the first area and the positioning AD for respective additional area. Again, depending on the type of positioning performed, PRS resources of the combined positioning AD may comprise a DL-PRS resource for the requesting UE to measure, an SL-PRS resource for the requesting UE to measure, or an SL-PRS resources for the requesting UE to transmit, or a combination thereof. Means for performing functionality at block 930 may comprise bus 1005, processing unit(s) 1010, digital signal processor (DSP) 1020, a wireless communication interface 1030, memory 1060, and/or other components of a UE 1000, as illustrated in FIG. 10.

At block 940, the functionality comprises performing an action in accordance to the combined positioning AD, wherein the action comprises measuring a PRS resource, transmitting a PRS resource, or both. As previously noted, for Uu positioning, the requesting UE may measure DL-PRS transmitted by one or more TRPs. For SL positioning, the requesting UE may measure SL-PRS transmitted by one or more other SL UEs, and/or the requesting UE may transmit SL-PRS to be measured by one or more other SL UEs. Means for performing functionality at block 940 may comprise bus 1005, processing unit(s) 1010, digital signal processor (DSP) 1020, a wireless communication interface 1030, memory 1060, and/or other components of a UE 1000, as illustrated in FIG. 10.

Alternative embodiments of the method 900 may include one or more variations to the functionality illustrated in FIG. 9. For example, according to some embodiments, the method 900 may further comprise determining the action to perform prior to performing the action, wherein determining the action to perform comprises using the differential information of the combined positioning AD to determine the action to perform. According to some embodiments, the difference may comprise a difference in priority of the PRS resources in the positioning AD for the first area, one or more PRS resources to add to the PRS resources of the positioning AD for the first area, or one or more PRS resources to omit from the PRS resources of the positioning AD for the first area, or a combination thereof.

Additionally or alternatively, embodiments may further comprise determining the action to perform prior to performing the action, wherein determining the action to perform comprises using a priority index included in the combined positioning AD to determine the action to perform. In such embodiments, the priority index may be indicative of a priority of each of the PRS resources for an additional area.

According to some embodiments, the method 900 may further comprise determining the action to perform prior to performing the action, wherein determining the action to perform is based, at least in part, on (i) the combined positioning AD; and (ii) a positioning frequency layer (PFL) of an additional area, a serving Transmission and Reception Points (TRP) of the additional area, a resource set of one or more PRS resources of the additional area, or one or more PRS resources of the additional area, or a combination thereof.

Again, particular functionality may apply where the areas comprise SL group zones. In particular, in some embodiments, the first area comprises a first SL group zone in which the requesting UE is located, the one or more additional areas comprise one or more additional SL group zones, and the area IDs comprise zone IDs of the first SL group zone and one or more additional SL group zones. In such embodiments, the combined positioning AD may comprise a SL-PRS or RP-P configuration associated with the first SL group zone and the one or more additional SL group zones.

FIG. 10 illustrates an embodiment of a UE 1000, which can be utilized as described herein above (e.g., in association with FIGS. 1-9). For example, the UE 1000 may correspond with the UE 105 in the figures and previously described, and may perform one or more of the functions of the method shown in FIGS. 8 and/or 9. It should be noted that FIG. 10 is meant only to provide a generalized illustration of various components, any or all of which may be utilized as appropriate. It can be noted that, in some instances, components illustrated by FIG. 10 can be localized to a single physical device and/or distributed among various networked devices. Furthermore, as previously noted, the functionality of the UE discussed in the previously described embodiments may be executed by one or more of the hardware and/or software components illustrated in FIG. 10.

The UE 1000 is shown comprising hardware elements that can be electrically coupled via a bus 1005 (or may otherwise be in communication, as appropriate). The hardware elements may include a processing unit(s) 1010 which can include without limitation one or more general-purpose processors, one or more special-purpose processors (such as digital signal processor (DSP) chips, graphics acceleration processors, application specific integrated circuits (ASICs), and/or the like), and/or other processing structures or means. As shown in FIG. 10, some embodiments may have a separate DSP 1020, depending on desired functionality. Location determination and/or other determinations based on wireless communication may be provided in the processing unit(s) 1010 and/or wireless communication interface 1030 (discussed below). The UE 1000 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The UE 1000 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 1000 to communicate with other devices as described in the embodiments above. The wireless communication interface 1030 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 1000 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000, WCDMA, and so on. CDMA2000 includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. Cdma2000 is described in documents from a consortium named “3rd Generation Partnership Project X3” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 1000 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 1000 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the UE 1000, using conventional techniques, from GNSS satellites 110 of a GNSS system, such as Global Positioning System (GPS), Galileo, GLONASS, Quasi-Zenith Satellite System (QZSS) over Japan, Indian Regional Navigational Satellite System (IRNSS) over India, BeiDou Navigation Satellite System (BDS) over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processing units, such as processing unit(s) 1010, DSP 1020, and/or a processing unit within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processing units, such as processing unit(s) 1010 or DSP 1020.

The UE 1000 may further include and/or be in communication with a memory 1060. The memory 1060 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the UE 1000 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the UE 1000 (and/or processing unit(s) 1010 or DSP 1020 within UE 1000). In an aspect, then such code and/or instructions can be used to configure and/or adapt a general-purpose computer (or other device) to perform one or more operations in accordance with the described methods.

FIG. 11 illustrates an embodiment of a TRP 1100, which can be utilized as described herein above (e.g., in association with FIGS. 1-10) with regard to base stations and/or TRPs described herein. As previously noted, a TRP 1100 may be utilized to perform one or more of the functions described in the method 800 of FIG. 8. It should be noted that FIG. 11 is meant only to provide a generalized illustration of various components, any or all of which may be utilized as appropriate.

The TRP 1100 is shown comprising hardware elements that can be electrically coupled via a bus 1105 (or may otherwise be in communication, as appropriate). The hardware elements may include a processing unit(s) 1110 which can include without limitation one or more general-purpose processors, one or more special-purpose processors (such as DSP chips, graphics acceleration processors, ASICs, and/or the like), and/or other processing structure or means. As shown in FIG. 11, some embodiments may have a separate DSP 1120, depending on desired functionality. Location determination and/or other determinations based on wireless communication may be provided in the processing unit(s) 1110 and/or wireless communication interface 1130 (discussed below), according to some embodiments. The TRP 1100 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The TRP 1100 might also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the TRP 1100 to communicate as described herein. The wireless communication interface 1130 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1132 that send and/or receive wireless signals 1134.

The TRP 1100 may also include a network interface 1180, which can include support of wireline communication technologies. The network interface 1180 may include a modem, network card, chipset, and/or the like. The network interface 1180 may include one or more input and/or output communication interfaces to permit data to be exchanged with a network, communication network servers, computer systems, and/or any other electronic devices described herein.

In many embodiments, the TRP 1100 may further comprise a memory 1160. The memory 1160 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1160 of the TRP 1100 also may comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the TRP 1100 (and/or processing unit(s) 1110 or DSP 1120 within TRP 1100). In an aspect, then such code and/or instructions can be used to configure and/or adapt a general-purpose computer (or other device) to perform one or more operations in accordance with the described methods.

FIG. 12 is a block diagram of an embodiment of a computer system 1200, which may be used, in whole or in part, to provide the functions of one or more network components as described in the embodiments herein (e.g., location server 160 of FIGS. 1, 3, and 6, and/or LMF of FIG. 2, etc.). It should be noted that FIG. 12 is meant only to provide a generalized illustration of various components, any or all of which may be utilized as appropriate. FIG. 12, therefore, broadly illustrates how individual system elements may be implemented in a relatively separated or relatively more integrated manner. In addition, it can be noted that components illustrated by FIG. 12 can be localized to a single device and/or distributed among various networked devices, which may be disposed at different geographical locations.

The computer system 1200 is shown comprising hardware elements that can be electrically coupled via a bus 1205 (or may otherwise be in communication, as appropriate). The hardware elements may include processing unit(s) 1210, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1200 also may comprise one or more input devices 1215, which may comprise without limitation a mouse, a keyboard, a camera, a microphone, and/or the like; and one or more output devices 1220, which may comprise without limitation a display device, a printer, and/or the like.

The computer system 1200 may further include (and/or be in communication with) one or more non-transitory storage devices 1225, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1200 may also include a communications subsystem 1230, which may comprise wireless communication technologies managed and controlled by a wireless communication interface 1233, as well as wired technologies (such as Ethernet, coaxial communications, universal serial bus (USB), and the like). The wireless communication interface 1233 may send and receive wireless signals 1255 (e.g., signals according to 5G NR or LTE) via wireless antenna(s) 1250. Thus the communications subsystem 1230 may comprise a modem, a network card (wireless or wired), an infrared communication device, a wireless communication device, and/or a chipset, and/or the like, which may enable the computer system 1200 to communicate on any or all of the communication networks described herein to any device on the respective network, including a User Equipment (UE), base stations and/or other TRPs, and/or any other electronic devices described herein. Hence, the communications subsystem 1230 may be used to receive and send data as described in the embodiments herein.

In many embodiments, the computer system 1200 will further comprise a working memory 1235, which may comprise a RAM or ROM device, as described above. Software elements, shown as being located within the working memory 1235, may comprise an operating system 1240, device drivers, executable libraries, and/or other code, such as one or more applications 1245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1225 described above. In some cases, the storage medium might be incorporated within a computer system, such as computer system 1200. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1200 and/or might take the form of source and/or installable code, which, upon compilation and/or installation on the computer system 1200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of positioning Assistance Data (AD) delivery for positioning a requesting user equipment (UE) in a wireless communication network, the method performed by a responding device and comprising: receiving a request, from the requesting UE, for positioning AD for a first area in which the requesting UE is located, wherein the request comprises an area identifier (ID) of the first area; determining a combined positioning AD based at least in part on the area ID, wherein the combined positioning AD includes: positioning AD for the first area comprising information regarding Positioning Reference Signal (PRS) resources, Base Station Almanac (BSA) information, or both, to be used for positioning the requesting UE within the first area, and positioning AD for one or more additional areas comprising, for each area of the one or more additional areas: an indication that the positioning AD for the first area also applies to the respective additional area, or differential information indicative of a difference between the positioning AD for the first area and the positioning AD for respective additional area; and sending the combined positioning AD to the requesting UE; wherein the first area and the one or more additional areas comprise: cells of the wireless communication network, or sidelink (SL) group zones.
Clause 2. The method of clause 1, wherein the one or more additional areas comprise one or more neighboring areas to the first area.
Clause 3. The method of any of clauses 1-2, wherein the first area and the one or more additional areas comprise cells of the wireless communication network, and wherein the cells correspond to a TRP, a TP, or a gNB with one or more identifiers comprising: a Physical Cell ID (PCI), an Absolute Radio-Frequency Channel Number (ARFCN), a New Radio (NR) Cell Global Identity (NCGI), or Transmission Reception Point ID (TRP-ID), or a combination thereof.
Clause 4. The method of any of clauses 1-3, wherein the PRS resources of the combined positioning AD comprise: a downlink PRS (DL-PRS) resource for the requesting UE to measure, a sidelink PRS (SL-PRS) resource for the requesting UE to measure, or an SL-PRS resources for the requesting UE to transmit, or a combination thereof.
Clause 5. The method of any of clauses 1-4, wherein the responding device comprises a location server, a Transmission and Reception Point (TRP), or a responding UE.
Clause 6. The method of any of clauses 1-5 wherein, for each area of the one or more additional areas, the difference between the positioning AD for the first area and the positioning AD for respective additional area comprises a difference in priority of the PRS resources in the positioning AD for the first area, one or more PRS resources to add to the PRS resources of the positioning AD for the first area, or one or more PRS resources to omit from the PRS resources of the positioning AD for the first area, or a combination thereof.
Clause 7. The method of any of clauses 1-6 wherein, for each area of the one or more additional areas, the positioning AD comprises a priority index indicative of a priority of each of the PRS resources for the respective additional area.
Clause 8. The method of any of clauses 1-7, wherein determining the combined positioning AD comprises identifying the one or more additional areas based, at least in part on information regarding: a historical position of the requesting UE, a current position of the requesting UE, a historical velocity of the requesting UE, a current velocity of the requesting UE, historical information regarding one or more additional UEs, or current information regarding one or more additional UEs, or a combination thereof.
Clause 9. The method of any of clauses 1-8 further comprising, determining the positioning AD for each area of the one or more additional areas, based, at least in part on: a positioning frequency layer (PFL) of the respective additional area, a serving TRP of the respective additional area, a resource set of one or more PRS resources of the respective additional area, or one or more PRS resources of the respective additional area, or a combination thereof.
Clause 10. The method of any of clauses 1-9 further comprising, limiting a number of the one or more additional areas for which positioning AD is included in the combined positioning AD based at least in part on a capability related to a maximum number of ADs the requesting UE can support.
Clause 11. The method of any of clauses 1-2 wherein the first area comprises a first SL group zone in which the requesting UE is located; the one or more additional areas comprise one or more additional SL group zones; and the area ID comprises a zone ID of the first SL group zone.
Clause 12. The method of any of clauses any of clauses 1-2 or 11, wherein the combined positioning AD comprises an SL-PRS or Resource Pool for Positioning (RP-P) configuration associated with the first SL group zone and the one or more additional SL group zones.
Clause 13. A method of positioning a requesting user equipment (UE) in a wireless communication network, the method performed by the requesting UE and comprising: determining an area identifier (ID) for a first area in which the requesting UE is located; sending, to a responding device, a request for positioning Assistance Data (AD) for the first area and one or more additional areas, wherein the request includes the area ID for the first area; receiving, from the responding device, a combined positioning AD comprising: the positioning AD for the first area comprising information regarding Positioning Reference Signal (PRS) resources, Base Station Almanac (BSA) information, or both, to be used for positioning the requesting UE within the first area, and the positioning AD for the one or more additional areas comprising, for each area of the one or more additional areas: an indication that the positioning AD for the first area also applies to the respective additional area, or differential information indicative of a difference between the positioning AD for the first area and the positioning AD for respective additional area; and performing an action in accordance to the combined positioning AD, wherein the action comprises measuring a PRS resource, transmitting a PRS resource, or both; wherein the first area and the one or more additional areas comprise: cells of the wireless communication network, or sidelink (SL) group zones.
Clause 14. The method of clause 13, further comprising determining the action to perform prior to performing the action, wherein determining the action to perform comprises using the differential information of the combined positioning AD to determine the action to perform.
Clause 15. The method of any of clauses 13-14 further comprising determining the action to perform prior to performing the action, wherein determining the action to perform comprises using a priority index included in the combined positioning AD to determine the action to perform, and wherein the priority index is indicative of a priority of each of the PRS resources for an additional area.
Clause 16. The method of any of clauses 13-15 further comprising determining area IDs of the one or more additional areas; and including, in the request for AD, the area IDs of the one or more additional areas.
Clause 17. The method of any of clauses 13-16, wherein determining the area IDs for the one or more additional areas comprises identifying the one or more additional areas based, at least in part on information regarding: a historical position of the requesting UE, a current position of the requesting UE, a historical velocity of the requesting UE, a current velocity of the requesting UE, historical information regarding one or more additional UEs, or current information regarding one or more additional at UEs, or a combination thereof.
Clause 18. The method of any of clauses 13-17 wherein the first area comprises a first SL group zone in which the requesting UE is located; the one or more additional areas comprise one or more additional SL group zones; and the area IDs comprise zone IDs of the first SL group zone and one or more additional SL group zones.
Clause 19. A responding device for providing positioning Assistance Data (AD) delivery for positioning a requesting user equipment (UE) in a wireless communication network, the responding device comprising: a transceiver; a memory; and one or more processing units communicatively coupled with the transceiver and the memory, the one or more processing units configured to: receive a request, from the requesting UE via the transceiver, for positioning AD for a first area in which the requesting UE is located, wherein the request comprises an area identifier (ID) of the first area; determine a combined positioning AD based at least in part on the area ID, wherein the combined positioning AD includes: positioning AD for the first area comprising information regarding Positioning Reference Signal (PRS) resources, Base Station Almanac (BSA) information, or both, to be used for positioning the requesting UE within the first area, and positioning AD for one or more additional areas comprising, for each area of the one or more additional areas: an indication that the positioning AD for the first area also applies to the respective additional area, or differential information indicative of a difference between the positioning AD for the first area and the positioning AD for respective additional area; and send the combined positioning AD to the requesting UE via the transceiver; wherein the first area and the one or more additional areas comprise: cells of the wireless communication network, or sidelink (SL) group zones.
Clause 20. The responding device of clause 19, wherein the responding device comprises a location server, a Transmission and Reception Point (TRP), or a responding UE.
Clause 21. The responding device of any of clauses 19-20, wherein the one or more processing units are configured to include, in the positioning AD for each area of the one or more additional areas, a priority index indicative of a priority of each of the PRS resources for the respective additional area.
Clause 22. The responding device of any of clauses 19-21, wherein the one or more processing units are further configured to determine the positioning AD for each area of the one or more additional areas, based, at least in part on: a positioning frequency layer (PFL) of the respective additional area, a serving TRP of the respective additional area, a resource set of one or more PRS resources of the respective additional area, or one or more PRS resources of the respective additional area, or a combination thereof.
Clause 23. The responding device of any of clauses 19-22, wherein the one or more processing units are further configured to limit a number of the one or more additional areas for which positioning AD is included in the combined positioning AD based at least in part on a capability related to a maximum number of ADs the requesting UE can support.
Clause 24. The responding device of any of clauses 19-23, wherein: the first area comprises a first SL group zone in which the requesting UE is located; the one or more additional areas comprise one or more additional SL group zones; and the area ID comprises a zone ID of the first SL group zone.
Clause 25. A requesting user equipment (UE) in a wireless communication network, the requesting UE comprising: a transceiver; a memory; and one or more processing units communicatively coupled with the transceiver and the memory, the one or more processing units configured to: determine an area identifier (ID) for a first area in which the requesting UE is located; send, to a responding device via the transceiver, a request for positioning Assistance Data (AD) for the first area and one or more additional areas, wherein the request includes the area ID for the first area; receive, from the responding device via the transceiver, a combined positioning AD comprising: the positioning AD for the first area comprising information regarding Positioning Reference Signal (PRS) resources, Base Station Almanac (BSA) information, or both, to be used for positioning the requesting UE within the first area, and the positioning AD for the one or more additional areas comprising, for each area of the one or more additional areas: an indication that the positioning AD for the first area also applies to the respective additional area, or differential information indicative of a difference between the positioning AD for the first area and the positioning AD for respective additional area; and perform an action in accordance to the combined positioning AD, wherein the action comprises measuring a PRS resource, transmitting a PRS resource, or both; wherein the first area and the one or more additional areas comprise: cells of the wireless communication network, or sidelink (SL) group zones.
Clause 26. The requesting UE of clause 25, wherein the one or more processing units are further configured to determine the action to perform prior to performing the action, wherein determining the action to perform comprises using the differential information of the combined positioning AD to determine the action to perform.
Clause 27. The requesting UE of any of clauses 25-26, wherein the one or more processing units are further configured to determine the action to perform prior to performing the action, wherein determining the action to perform comprises using a priority index included in the combined positioning AD to determine the action to perform, and wherein the priority index is indicative of a priority of each of the PRS resources for an additional area.
Clause 28. The requesting UE of any of clauses 25-27, wherein the one or more processing units are further configured to: determine area IDs of the one or more additional areas; and include, in the request for AD, the area IDs of the one or more additional areas.
Clause 29. The requesting UE of any of clauses 25-28, wherein the one or more processing units are further configured to determine the action to perform prior to performing the action, wherein determining the action to perform is based, at least in part, on the combined positioning AD and: a positioning frequency layer (PFL) of an additional area, a serving TRP of the additional area, a resource set of one or more PRS resources of the additional area, or one or more PRS resources of the additional area, or a combination thereof.
Clause 30. The requesting UE of any of clauses 25-29 wherein the first area comprises a first SL group zone in which the requesting UE is located; the one or more additional areas comprise one or more additional SL group zones; and the area IDs comprise zone IDs of the first SL group zone and one or more additional SL group zones.
Clause 31. A non-transitory computer-readable medium storing instructions comprising code for performing the methods of any of clauses 1-30.
Clause 32. A device having means for performing the methods of any of clauses 1-30.

What is claimed is:

1. A method of positioning Assistance Data (AD) delivery for positioning a requesting user equipment (UE) in a wireless communication network, the method performed by a responding device and comprising:
receiving a request, from the requesting UE, for positioning AD for a first area in which the requesting UE is located, wherein the request comprises an area identifier (ID) of the first area;
determining a combined positioning AD based at least in part on the area ID, wherein the combined positioning AD includes:
positioning AD for the first area comprising information regarding Positioning Reference Signal (PRS) resources, Base Station Almanac (BSA) information, or both, to be used for positioning the requesting UE within the first area, and
positioning AD for one or more additional areas comprising, for each area of the one or more additional areas:
an indication that the positioning AD for the first area also applies to the respective additional area, or
differential information indicative of a difference between the positioning AD for the first area and the positioning AD for respective additional area; and
sending the combined positioning AD to the requesting UE;
wherein the first area and the one or more additional areas comprise:
cells of the wireless communication network, or
sidelink (SL) group zones.

2. The method of claim 1, wherein the one or more additional areas comprise one or more neighboring areas to the first area.

3. The method of claim 1, wherein the first area and the one or more additional areas comprise cells of the wireless communication network, and wherein the cells correspond to a TRP, a TP, or a gNB with one or more identifiers comprising:
a Physical Cell ID (PCI),
an Absolute Radio-Frequency Channel Number (ARFCN),
a New Radio (NR) Cell Global Identity (NCGI), or
Transmission Reception Point ID (TRP-ID), or
a combination thereof.

4. The method of claim 1, wherein the PRS resources of the combined positioning AD comprise:
a downlink PRS (DL-PRS) resource for the requesting UE to measure,
a sidelink PRS (SL-PRS) resource for the requesting UE to measure, or
an SL-PRS resources for the requesting UE to transmit, or
a combination thereof.

5. The method of claim 1, wherein the responding device comprises a location server, a Transmission and Reception Point (TRP), or a responding UE.

6. The method of claim 1, wherein, for each area of the one or more additional areas, the difference between the positioning AD for the first area and the positioning AD for respective additional area comprises:
a difference in priority of the PRS resources in the positioning AD for the first area,
one or more PRS resources to add to the PRS resources of the positioning AD for the first area, or
one or more PRS resources to omit from the PRS resources of the positioning AD for the first area, or
a combination thereof.

7. The method of claim 1, wherein, for each area of the one or more additional areas, the positioning AD comprises a priority index indicative of a priority of each of the PRS resources for the respective additional area.

8. The method of claim 1, wherein determining the combined positioning AD comprises identifying the one or more additional areas based, at least in part on information regarding:
a historical position of the requesting UE,
a current position of the requesting UE,
a historical velocity of the requesting UE,
a current velocity of the requesting UE,
historical information regarding one or more additional UEs, or
current information regarding one or more additional UEs, or
a combination thereof.

9. The method of claim 1, further comprising determining the positioning AD for each area of the one or more additional areas, based, at least in part on:
a positioning frequency layer (PFL) of the respective additional area,
a serving TRP of the respective additional area,
a resource set of one or more PRS resources of the respective additional area, or
one or more PRS resources of the respective additional area, or
a combination thereof.

10. The method of claim 1, further comprising limiting a number of the one or more additional areas for which positioning AD is included in the combined positioning AD based at least in part on a capability related to a maximum number of ADs the requesting UE can support.

11. The method of claim 1, wherein:
the first area comprises a first SL group zone in which the requesting UE is located;
the one or more additional areas comprise one or more additional SL group zones; and
the area ID comprises a zone ID of the first SL group zone.

12. The method of claim 11, wherein the combined positioning AD comprises an SL-PRS or Resource Pool for Positioning (RP-P) configuration associated with the first SL group zone and the one or more additional SL group zones.

13. A method of positioning a requesting user equipment (UE) in a wireless communication network, the method performed by the requesting UE and comprising:
determining an area identifier (ID) for a first area in which the requesting UE is located;
sending, to a responding device, a request for positioning Assistance Data (AD) for the first area and one or more additional areas, wherein the request includes the area ID for the first area;
receiving, from the responding device, a combined positioning AD comprising:
the positioning AD for the first area comprising information regarding Positioning Reference Signal (PRS) resources, Base Station Almanac (BSA) information, or both, to be used for positioning the requesting UE within the first area, and
the positioning AD for the one or more additional areas comprising, for each area of the one or more additional areas:
an indication that the positioning AD for the first area also applies to the respective additional area, or
differential information indicative of a difference between the positioning AD for the first area and the positioning AD for respective additional area; and
performing an action in accordance to the combined positioning AD, wherein the action comprises measuring a PRS resource, transmitting a PRS resource, or both;
wherein the first area and the one or more additional areas comprise:
cells of the wireless communication network, or
sidelink (SL) group zones.

14. The method of claim 13, further comprising determining the action to perform prior to performing the action, wherein determining the action to perform comprises using the differential information of the combined positioning AD to determine the action to perform.

15. The method of claim 13, further comprising determining the action to perform prior to performing the action, wherein determining the action to perform comprises using a priority index included in the combined positioning AD to determine the action to perform, and wherein the priority index is indicative of a priority of each of the PRS resources for an additional area.

16. The method of claim 13, further comprising:
determining area IDs of the one or more additional areas; and
including, in the request for AD, the area IDs of the one or more additional areas.

17. The method of claim 13, wherein determining the area IDs for the one or more additional areas comprises identifying the one or more additional areas based, at least in part on information regarding:
a historical position of the requesting UE,
a current position of the requesting UE,
a historical velocity of the requesting UE,
a current velocity of the requesting UE,
historical information regarding one or more additional UEs, or
current information regarding one or more additional at UEs, or
a combination thereof.

18. The method of claim 13, wherein:
the first area comprises a first SL group zone in which the requesting UE is located;
the one or more additional areas comprise one or more additional SL group zones; and
the area IDs comprise zone IDs of the first SL group zone and one or more additional SL group zones.

19. A responding device for providing positioning Assistance Data (AD) delivery for positioning a requesting user equipment (UE) in a wireless communication network, the responding device comprising:
a transceiver;
a memory; and
one or more processing units communicatively coupled with the transceiver and the memory, the one or more processing units configured to:
receive a request, from the requesting UE via the transceiver, for positioning AD for a first area in which the requesting UE is located, wherein the request comprises an area identifier (ID) of the first area;
determine a combined positioning AD based at least in part on the area ID, wherein the combined positioning AD includes:
positioning AD for the first area comprising information regarding Positioning Reference Signal (PRS) resources, Base Station Almanac (BSA) information, or both, to be used for positioning the requesting UE within the first area, and
positioning AD for one or more additional areas comprising, for each area of the one or more additional areas:
an indication that the positioning AD for the first area also applies to the respective additional area, or
differential information indicative of a difference between the positioning AD for the first area and the positioning AD for respective additional area; and
send the combined positioning AD to the requesting UE via the transceiver;
wherein the first area and the one or more additional areas comprise:
cells of the wireless communication network, or
sidelink (SL) group zones.

20. The responding device of claim 19, wherein the responding device comprises a location server, a Transmission and Reception Point (TRP), or a responding UE.

21. The responding device of claim 20, wherein the one or more processing units are configured to include, in the positioning AD for each area of the one or more additional areas, a priority index indicative of a priority of each of the PRS resources for the respective additional area.

22. The responding device of claim 19, wherein the one or more processing units are further configured to determine the positioning AD for each area of the one or more additional areas, based, at least in part on:
a positioning frequency layer (PFL) of the respective additional area,
a serving TRP of the respective additional area,
a resource set of one or more PRS resources of the respective additional area, or
one or more PRS resources of the respective additional area, or
a combination thereof.

23. The responding device of claim 19, wherein the one or more processing units are further configured to limit a number of the one or more additional areas for which positioning AD is included in the combined positioning AD based at least in part on a capability related to a maximum number of ADs the requesting UE can support.

24. The responding device of claim 20, wherein:
the first area comprises a first SL group zone in which the requesting UE is located;
the one or more additional areas comprise one or more additional SL group zones; and
the area ID comprises a zone ID of the first SL group zone.

25. A requesting user equipment (UE) in a wireless communication network, the requesting UE comprising:
a transceiver;
a memory; and
one or more processing units communicatively coupled with the transceiver and the memory, the one or more processing units configured to:
determine an area identifier (ID) for a first area in which the requesting UE is located;
send, to a responding device via the transceiver, a request for positioning Assistance Data (AD) for the first area and one or more additional areas, wherein the request includes the area ID for the first area;
receive, from the responding device via the transceiver, a combined positioning AD comprising:
the positioning AD for the first area comprising information regarding Positioning Reference Signal (PRS) resources, Base Station Almanac (BSA) information, or both, to be used for positioning the requesting UE within the first area, and
the positioning AD for the one or more additional areas comprising, for each area of the one or more additional areas:
an indication that the positioning AD for the first area also applies to the respective additional area, or
differential information indicative of a difference between the positioning AD for the first area and the positioning AD for respective additional area; and
perform an action in accordance to the combined positioning AD, wherein the action comprises measuring a PRS resource, transmitting a PRS resource, or both;
wherein the first area and the one or more additional areas comprise:
cells of the wireless communication network, or
sidelink (SL) group zones.

26. The requesting UE of claim 25, wherein the one or more processing units are further configured to determine the action to perform prior to performing the action, wherein determining the action to perform comprises using the differential information of the combined positioning AD to determine the action to perform.

27. The requesting UE of claim 25, wherein the one or more processing units are further configured to determine the action to perform prior to performing the action, wherein determining the action to perform comprises using a priority index included in the combined positioning AD to determine the action to perform, and wherein the priority index is indicative of a priority of each of the PRS resources for an additional area.

28. The requesting UE of claim 25, wherein the one or more processing units are further configured to:
determine area IDs of the one or more additional areas; and
include, in the request for AD, the area IDs of the one or more additional areas.

29. The requesting UE of claim 25, wherein the one or more processing units are further configured to determine the action to perform prior to performing the action, wherein determining the action to perform is based, at least in part, on the combined positioning AD and:
a positioning frequency layer (PFL) of an additional area,
a serving TRP of the additional area,
a resource set of one or more PRS resources of the additional area, or
one or more PRS resources of the additional area, or
a combination thereof.

30. The requesting UE of claim 26, wherein:
the first area comprises a first SL group zone in which the requesting UE is located;
the one or more additional areas comprise one or more additional SL group zones; and
the area IDs comprise zone IDs of the first SL group zone and one or more additional SL group zones.
